(19) United States
(12) Patent Application Publication
(10) Pub. No.: US 2026/0181491 A1
(43) Pub. Date: Jun. 25, 2026

(54) A METHOD TO TRANSMIT AND RECEIVE DATA AND CONTROL INFORMATION [INTER-CELL SWITCHING]

(71) Applicants: Samsung Electronics Co., Ltd., Gyeonggi-do (KR); BEIJING SAMSUNG TELECOMMUNICATIONS TECHNOLOGY RESEARCH CO., LTD., Beijing (CN)

(72) Inventors: Jingxing FU, Beijing (CN); Feifei SUN, Beijing (CN); Zhe CHEN, Beijing (CN)

(21) Appl. No.: 19/125,857

(22) PCT Filed: Nov. 1, 2023
(86) PCT No.: PCT/KR2023/017233

§ 371 Date: Apr. 30, 2025

(30) Foreign Application Priority Data
Nov. 4, 2022 (CN) 202211380031.5

(51) Int. Cl. H04W 36/00

(52) U.S. Cl. CPC H04W 36/0061

(57) ABSTRACT

The disclosure relates to a 5G or 6G communication system for supporting a higher data transmission rate. Embodiments of the present application provide a communication method, a user equipment, a base station, and a storage medium, in the method, the UE receives from a base station first configuration information related to candidate cells of serving cells, and receives from the base station second configuration information related to candidate cell measurement, wherein under the circumstance in which there are overlapping candidate cells of serving cells, the overlapping candidate cells of at least two serving cells are configured with a same measurement configuration, so that cell measurement is performed based on the second configuration information, to facilitate the base station to select a suitable candidate cell for dynamic switching, that is, during the UE cell switching process, for overlapping candidate cells of at least two serving cells, the configured measurement configurations are few in quantity, thus saving measurement report of UE, and hence enhancing the performance of UE.

### TECHNICAL FIELD

The present application relates to the technical field of wireless communication, and in particular to a communication method, a user equipment (UE), a base station (BS), and a storage medium.

### BACKGROUND ART

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window su-perposition coding (SWSC) as advanced coding modulation (ACM), and filter bank multicarrier (FBMC), non-orthogonal multiple access (NOMA) and sparse code multiple access (SCMA) as advanced access technologies have been developed.

The moving characteristic of the UE necessitates the UE to be switched among cells to ensure continuity of communication, but the current cell switching technology still leaves something to be improved.

### DISCLOSURE OF INVENTION

### Technical Problem

The present disclosure relates to wireless communication systems and, more specifically, the invention relates to node in wireless communication system and method performed by the same.

### Solution to Problem

Embodiments of the present application aim to solve the technical defect present in the cell switching technology.

According to a first aspect of the embodiments of the present application, there is provided a method performed by a UE in a communication system, and the method comprises:
receiving from a base station first configuration information related to candidate cells of serving cells;
receiving from the base station second configuration information related to measurement of the candidate cell; and

performing cell measurement based on the second configuration information;
wherein, under the circumstance in which there are overlapping candidate cells of the serving cells, overlapping candidate cells of at least two serving cells are configured with a same measurement configuration.

According to another aspect of the embodiments of the present application, there is provided a method performed by a UE in a communication system, and the method comprises:
receiving from a base station configuration information related to a candidate cell set, wherein the candidate cell set includes candidate cells of at least one serving cell; and

receiving from the base station configuration information related to the candidate cells in the candidate cell set.

According to still another aspect of the embodiments of the present application, there is provided a method performed by a base station in a communication system, and the method comprises:
transmitting to a UE first configuration information related to candidate cells of a serving cell of the UE; and

transmitting to the UE second configuration information related to candidate cell measurement, wherein the second configuration information is used for the UE to perform cell measurement;
wherein, under the circumstance in which there are overlapping candidate cells of serving cells, the overlapping candidate cells of at least two serving cells are configured with a same measurement configuration.

According to yet another aspect of the embodiments of the present application, there is provided a method performed by a base station in a communication system, and the method comprises:
transmitting to a UE configuration information related to a candidate cell set, wherein the candidate cell set includes candidate cells of at least one serving cell; and
transmitting to the UE configuration information related to each candidate cell in the candidate cell set.

According to a further aspect of the embodiments of the present application, there is provided a UE, and the UE comprises:
a transceiver; and
a processor, coupled with the transceiver and configured to perform the method performed by a UE provided by the embodiments of the present application.

According to a still further aspect of the embodiments of the present application, there is provided a base station, and the base station comprises:
a transceiver; and
a processor, coupled with the transceiver and configured to perform the method performed by a base station provided by the embodiments of the present application.

According to another aspect of the embodiments of the present application, there is provided a computer readable storage medium, storing thereon a computer program, and the computer program, when executed by a processor, realizes the method performed by a UE provided by the embodiments of the present application.

According to still another aspect of the embodiments of the present application, there is provided a computer readable storage medium, storing thereon a computer program, and the computer program, when executed by a processor, realizes the method performed by a base station provided by the embodiments of the present application.

According to a further aspect of the embodiments of the present application, there is provided a computer program product that comprises a computer program, and the computer program, when executed by a processor, realizes the method performed by a UE provided by the embodiments of the present application.

According to a still further aspect of the embodiments of the present application, there is provided a computer program product that comprises a computer program, and the computer program, when executed by a processor, realizes the method performed by a UE provided by the embodiments of the present application.

In the communication method, user equipment, base station and storage medium provided by the embodiments of the present application, the UE receives from the base station first configuration information related to candidate cells of serving cells, and receives from the base station second configuration information related to candidate cell measurement, wherein, under the circumstance in which there are overlapping candidate cells of the serving cells, the overlapping candidate cells of at least two serving cells are configured with the same measurement configuration, to hence base on the second configuration information to perform cell measurement, so as to facilitate the base station to select a suitable candidate cell to perform dynamic switching, that is, during the process of cell switching of the UE, with respect to overlapping candidate cells of at least two serving cells, the configured measurement configurations are small in quantity, measurement reporting by the UE can be saved, and hence the performance of the UE is enhanced.

### Advantageous Effects of Invention

Advantages, and salient features of the invention will become apparent to those skilled in the art from the following detailed description, which, taken in conjunction with the annexed drawings, discloses exemplary embodiments of the invention.

### BRIEF DESCRIPTION OF DRAWINGS

In order to explain the technical solutions in the embodiments of the present disclosure more clearly, the drawings used in the description of the embodiments of the present disclosure will be briefly illustrated below.

FIG. 1 is a view schematically illustrating the overall structure of the wireless network provided by the embodiments of the present application;

FIG. 2a is a view schematically illustrating the transmission path provided by the embodiments of the present application;

FIG. 2b is a view schematically illustrating the reception path provided by the embodiments of the present application;

FIG. 3a is a view schematically illustrating the structure of the UE provided by the embodiment of the present application;

FIG. 3b is a view schematically illustrating the structure of the base station provided by the embodiment of the present application;

FIG. 4 is a flowchart schematically illustrating a method performed by a UE provided by an embodiment of the present application;

FIG. 5 is a flowchart schematically illustrating another method performed by a UE provided by an embodiment of the present application;

FIG. 6 is a view schematically illustrating a cell dynamic switching process provided by the embodiments of the present application;

FIG. 7 is a view schematically illustrating a cell dynamic switching configuration provided by the embodiments of the present application;

FIG. 8 is a view schematically illustrating a cell dynamic post use configuration provided by the embodiments of the present application;

FIG. 9 is a view schematically illustrating another cell dynamic switching configuration provided by the embodiments of the present application;

FIG. 10 is a view schematically illustrating another cell dynamic post use configuration provided by the embodiments of the present application;

FIG. 11 is a flowchart schematically illustrating another method performed by a UE provided by an embodiment of the present application;

FIG. 12 is a view schematically illustrating yet another cell dynamic switching configuration provided by the embodiments of the present application;

FIG. 13 is a view schematically illustrating still another cell dynamic post use configuration provided by the embodiments of the present application; and
FIG. 14 is a view schematically illustrating an electronic equipment provided by an embodiment of the present application.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents. It is to be understood that the singular forms “a,” “an,” and “the” include plural [61] referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

To make lucid and clear the objectives, technical solutions and advantages of the present application, the embodiments of the present application will be described in greater detail below in conjunction with the accompanying drawings.

The texts and the drawings are merely provided by way of examples to help readers comprehend the present application. They are neither intended nor should be explained to restrict the scope of the present application in any way. Although certain embodiments and examples have been provided, on the basis of the contents disclosed by this paper, it is obvious to persons skilled in the art that the illustrated embodiments and examples can be modified without departing from the scope of the present application.

In a wireless communication network, the transmission from a base station to a UE is referred to as downlink (DL), and the transmission from the UE to the base station is referred to as uplink (UL).

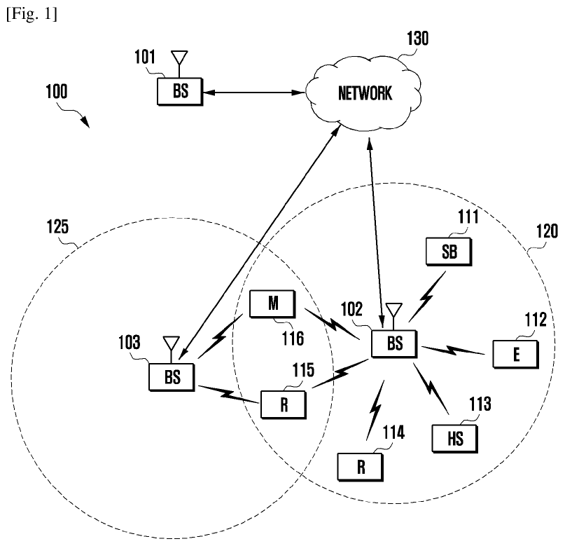

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network in-frastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio en-vironment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

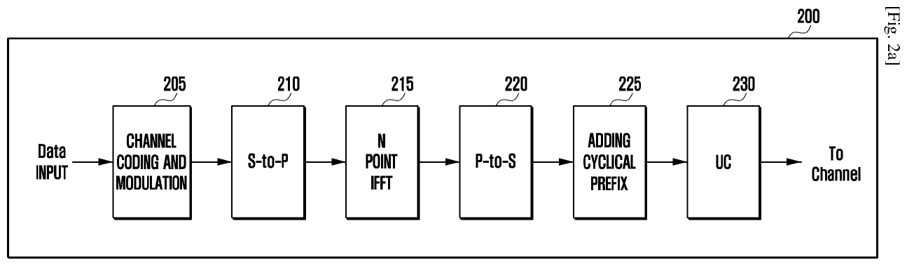

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

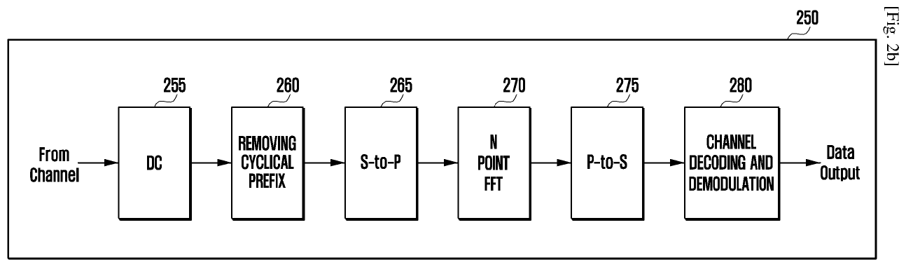

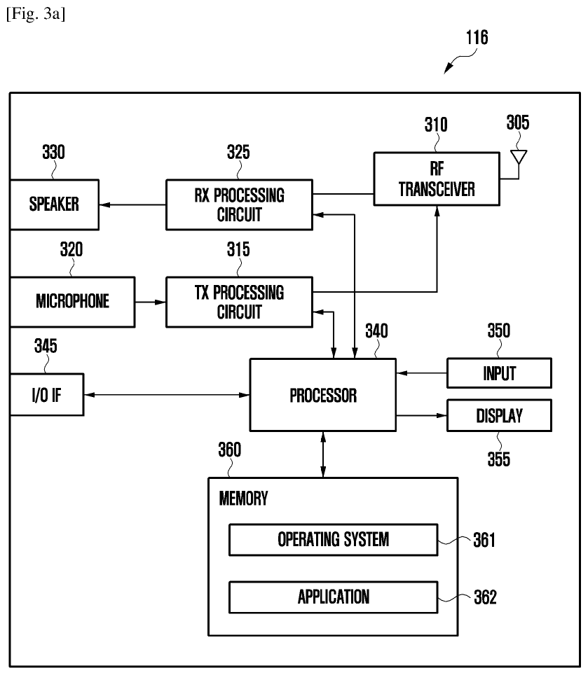

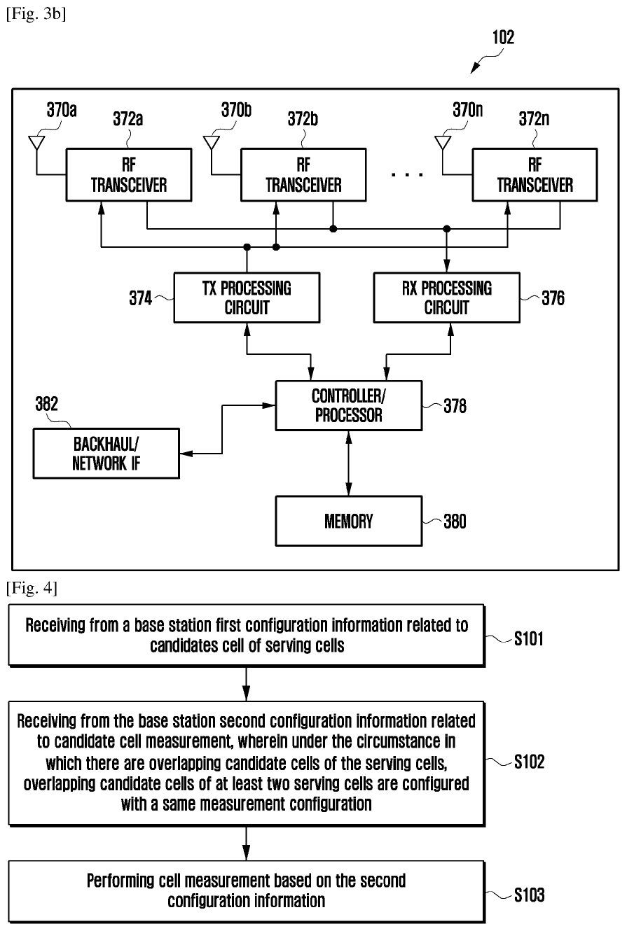

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these ac-cessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, the UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by the UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

As can be understood, the technical solutions provided by the embodiments of the present application can be applicable, but are not limited to, the wireless network.

To make clearer the objectives, technical solutions and advantageous of the present application, the technical solutions of the present application and the technical effects produced by the technical solutions of the present application are described through several exemplary embodiments. As should be pointed out, the following embodiments can be referred to, used as reference to, and combined with one another, for the same technical terms, similar features and similar implementing steps in different embodiments, no repetitive description is made.

An embodiment of the present application provides a method performed by a UE in a communication system, as shown in FIG. 4, the method comprises:
Step S101: receiving from a base station first configuration information related to candidates cell of serving cells;
Step S102: receiving from the base station second configuration information related to measurement of the candidate cell; and
Step S103: performing cell measurement based on the second configuration information.

Wherein, under the circumstance in which there are overlapping candidate cells of the serving cells, overlapping candidate cells of at least two serving cells are configured with a same measurement configuration.

As for the embodiments of the present application, in order to ensure the performance of the UE to transmit information, before the base station transmits a switching command, the UE reports the measurement results of channel statuses of various candidate cells, so as to facilitate the base station to select a suitable candidate cell to perform dynamic switching.

In the embodiments of the present application, measurement of the candidate cells includes, but is not limited to, Transceiver Configuration Indicator (TCI) status measurement, and Reference Signal Receiving Power (RSRP) measurement, etc.

In the embodiments of the present application, the UE can be configured with one or more serving cell(s), including, but not limited to, primary cell (Pcell), secondary cell (Scell), Physical Uplink Control Channel (PUCCH) secondary cell. That is to say, cell switching can include, but is not limited to, at least one of primary cell switching, secondary cell switching, and PUCCH secondary cell switching. Wherein, the PUCCH secondary cell means a secondary cell that can transmit PUCCH, while a secondary cell (Scell) can also be referred to as a general secondary cell, and the general secondary cell cannot transmit PUCCH. The general secondary cell and the PUCCH secondary cell can also be collectively referred to as secondary cells. That is, in the following description, a secondary cell may be meant for a general secondary cell (Scell) and/or a PUCCH secondary cell (Scell).

In step S101 of the embodiment of the present application, the UE receives from the base station first configuration information related to candidate cells of serving cells. Optionally, it can be that one candidate cell corresponds to one piece of first con-[112] figuration information, and it can also be that a plurality of candidate cells correspond to one piece of first configuration information.

Optionally, the first configuration information to which each candidate cell corresponds is configured through a high-layer signaling, or the first configuration information to which a plurality of candidate cells correspond is configured through a high-layer signaling.

In addition, each serving cell can be configured with one or more candidate cell(s) for cell switching, wherein each candidate cell can mean one cell, and can also mean a plurality of cells by carrier aggregation.

In the embodiments of the present application, one candidate cell can be a candidate cell of one serving cell, for instance, one candidate cell can be a candidate cell of a primary cell, alternatively, one candidate cell can be a candidate cell of a general secondary cell, or can also be a candidate cell of a PUCCH secondary cell, but this is not limited hereto.

Alternatively, candidate cells can also be candidate cells of a plurality of serving cells, that is to say, candidate cells can be overlapping candidate cells of different serving cells. For instance, a candidate cell can simultaneously be the candidate cell of a primary cell and a secondary cell, or a candidate cell can also simultaneously be the candidate cell of at least two secondary cells, to which no restriction is made here.

In the embodiments of the present application, under the circumstance there are overlapping candidate cells of serving cells, the overlapping candidate cells of at least two serving cells are configured with the same measurement configuration. As can also be understood, the overlapping candidate cells of N different serving cells are configured with M measurement configurations, where M<N,N≥2.

Exemplarily, one candidate cell is simultaneously the candidate cell of a primary cell and a secondary cell, that is, this candidate cell is an overlapping cell of two serving cells (N=2), under such circumstance, the overlapping candidate cell of the two serving cells is configured with the same measurement configuration, that is, the candidate cell is merely configured with a measurement configuration (M=1), then M=1<N=2, thus making it possible to effectively save measurement report of the UE about the candidate cell.

Again exemplarily, one candidate cell is the candidate cell of a primary cell, secondary cell 1 and secondary cell 2, that is, the candidate cell is the overlapping candidate cell of three serving cells (N=3), under such circumstance, the overlapping candidate cell of the three serving cells is configured with the same measurement configuration, that is, the candidate cell is merely configured with one measurement configuration (M=1), then M=1<N=3, thus saving measurement report of the UE about the candidate cell to the greatest degree; alternatively, it is also possible that at least two overlapping candidate cells in the three serving cells are configured with the same measurement configuration, for instance, the primary cell corresponds to a measurement configuration, the two secondary cells are configured with the same measurement configuration, namely corresponding to one measurement configuration (M=2), but this is not limited hereto, and other configuration modes can also be employed, then M=2<N=3, thus also making it possible to save measurement report of the UE about the candidate cells.

In the embodiments of the present application, the overlapping candidate cell being configured with the same measurement configuration includes at least one of the following circumstances:

(1) overlapping candidate cell is configured with the same second configuration information.

That is to say, as for the overlapping candidate cell of two serving cells, the base station merely dispatch one piece of second configuration information with respect to this candidate cell. Taking for example that one candidate cell is simultaneously the candidate cell of a primary cell and a secondary cell, the base station can dispatch only one piece of second configuration information for the candidate cell. For instance, when the base station identifies that this candidate cell serves as the candidate cell of the primary cell, and one piece of second configuration information has been dispatched, when it is again identified that this candidate cell serves as the candidate cell of a secondary cell, the second configuration information is no longer dispatched, but this is not limited hereto, as other judgment modes or configuration modes can also be employed.

(2) overlapping candidate cell is configured with the same measurement identifier

That is to say, as for an overlapping candidate cell of at least two serving cells, the base station respectively dispatch one piece of second configuration information for the candidate cell serving as the candidate cell of the different serving cells. Taking for example one candidate cell is simultaneously the candidate cell of a primary cell and a secondary cell, the base station can dispatch one piece or two pieces of second configuration information for the candidate cell. For instance, when the base station identifies that the candidate cell serves as the candidate cell of a primary cell, and one piece of second configuration information has been dispatched, when it is again identified that the candidate cell serves as the candidate cell of a secondary cell, one piece of second configuration information with the same measurement identifier is dispatched, but this is not limited hereto, as other judgment modes or configuration modes can also be employed. Then, the UE can merely perform one cell measurement with respect to a plurality of pieces of second configuration information with the same measurement identifier.

In the embodiments of the present application, optionally, candidate cells corresponding to all serving cell types among the overlapping candidate cells are all configured with the same measurement configuration. For instance, taking for example that one candidate cell is simultaneously the candidate cell of a primary cell and two secondary cells, the base station can merely dispatch one piece of second configuration information for the overlapping candidate cell of three serving cells of two serving cell types.

Alternatively, optionally, candidate cells corresponding to the first type service among the overlapping candidate cells are configured with the same first measurement configuration, candidate cells corresponding to the second type serving cell among the overlapping candidate cells are configured with the same second measurement configuration. The dispatched measurement configurations can also be differentiated according to the candidate cells corresponding to serving cell types. Optionally, a first type serving cell is the primary cell, a second type serving cell is a secondary cell, for instance, serving cells of primary cells and serving cells of secondary cells can be configured with different measurement configurations, while serving cells with plural overlapping secondary cells can be configured with the same measurement configuration; and/or, the first type serving cell is a PUCCH secondary cell, the second type serving cell is another secondary cell (e.g., a general secondary cell), for instance, the serving cell of the PUCCH secondary cell and the serving cell of the general secondary cell can be configured with different measurement configurations, while overlapping serving cells of a plurality of general secondary cells can be configured with the same measurement configuration. In actual application, it is possible to base on actual circumstance to set up serving cell types that can be configured with the same measurement configuration, to which no restriction is made in the embodiment of the present application.

In the method performed by the UE provided by an embodiment of the present application, the UE receives from the base station first configuration information related to candidate cells of serving cells, and receives from the base station second configuration information related to candidate cell measurement, wherein, under the circumstance in which there are overlapping candidate cells of the serving cells, the overlapping candidate cells of at least two serving cells are configured with the same measurement configuration, to hence base on the second configuration information to perform cell measurement, so as to facilitate the base station to select a suitable candidate cell to perform dynamic switching, that is, during the process of cell switching of the UE, with respect to overlapping candidate cells of at least two serving cells, the configured measurement configurations are small in quantity, measurement reporting by the UE can be saved, and hence the performance of the UE is enhanced.

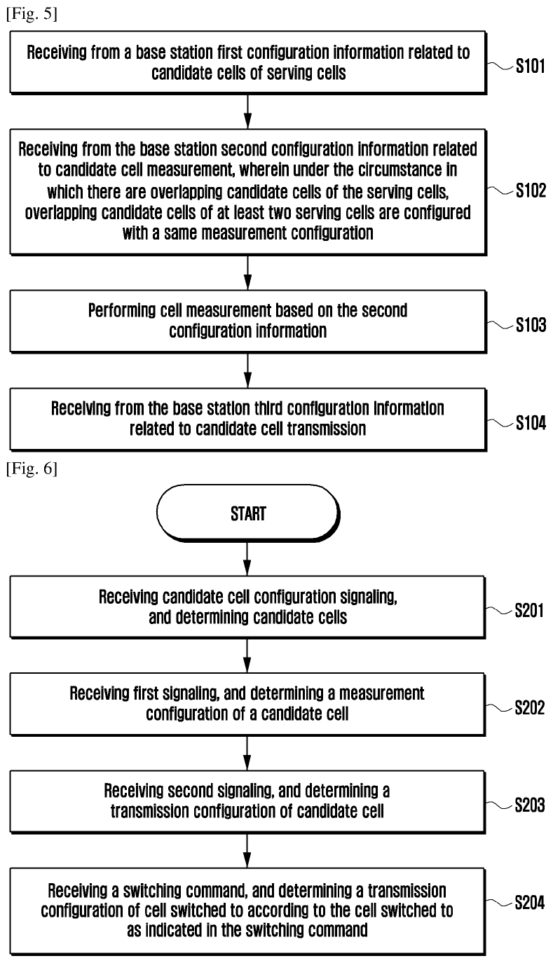

In the embodiment of the present application, on the basis of FIG. 4, as shown in FIG. 5, the method can further comprise:

Step S104: receiving from the base station third configuration information related to candidate cell transmission.

As for the embodiments of the present application, in order to be able to accurately transmit information after switching cell of the UE, before transmitting the switching command, the base station configures third configuration information of various candidate cells, so as to facilitate the UE to be ascertained as how to transmit information after cell switching.

In the embodiments of the present application, transmission at the UE side includes, but is not limited to, transmitting signal/signaling, transmitting data, receiving signal/signaling (such as control information), and receiving data, etc. The third configuration information includes, but is not limited to, control resource set (CORESET) configuration, search space configuration, physical uplink control channel (PUCCH) configuration, physical uplink shared channel (PUSCH) configuration, physical downlink control channel (PDCCH) configuration, and physical downlink shared channel (PDSCH) configuration of the candidate cells.

In the embodiments of the present application, each candidate cell is configured with at least one set of third configuration information.

Optionally, as for an overlapping candidate cell of at least two serving cells, when the candidate cell services as the candidate cell of different serving cells, the corresponding third configuration information can be respectively configured. That is to say, for an overlapping candidate cell of N different serving cells, the third configuration information corresponding to the different serving cells is all independently configured (totaling N pieces). Wherein, respective and independent configuration can be correspondingly (individually) configured through different pieces of third configuration information, but this is not limited hereto. Alternatively, for an overlapping candidate cell of N serving cells, it serves as the candidate cell of at least one serving cell to be configured with the corresponding third configuration information (less than N pieces), while it is not required to configure corresponding to all serving cells.

Exemplarily, one candidate cell is simultaneously the candidate cell of a primary cell and a secondary cell, under such circumstance, it is respectively independently configured with the third configuration information as the candidate cell of the primary cell and the third configuration information as the candidate cell of the secondary cell, whereby the transmission and reception requirements as the candidate cell of the primary cell and the secondary cell can be satisfied at the same time. Alternatively, it is also possible to base on characteristic of the candidate cell to merely independently configure suitable third configuration information for it, for instance, corresponding to one candidate cell that cannot transmit Synchronization Signal Block (SSB), even if it is configured as the candidate cell for both the primary cell and the secondary cell, it is also not needed to configure third configuration information as the candidate cell of the primary cell, while it suffices to merely configure for it third configuration information as the candidate cell of the secondary cell.

In the embodiments of the present application, the sets of third configuration information configured for different candidate cells can be identical or different. For instance, with respect to different circumstances, for a candidate cell it is possible to merely configure third configuration information as the candidate cell of the primary cell, it is also possible to merely configure third information as the candidate cell of the secondary cell, and it is also possible to not only configure the third configuration information as the candidate cell of the primary cell, but also configure the third configuration information as the candidate cell of the secondary cell.

In the embodiments of the present application, as for candidate cells of at least two serving cells, when the candidate cells serve as candidate cells of different serving cells, the corresponding third configuration information is respectively configured, including at least one of the following circumstances:

(1) At least two candidate cells serve as candidate cells of not entirely identical serving cells.

Exemplarily, one candidate cell is merely the candidate cell of the primary cell, another candidate cell is the candidate cell of a secondary cell, still another candidate cell is simultaneously the candidate cell of the primary cell and the secondary cell. Then, these three candidate cells can be understood as serving as candidate cells of not entirely identical serving cells. That is, in the embodiments of the present application, each candidate cell must not be necessarily the candidate cell of all the serving cells, and the candidate lists of each serving cell can be different.

As for the embodiments of the present application, as one or more candidate cell(s) of the candidate cells of a primary cell, corresponding third configuration information is independently configured, as one or more candidate cell(s) of the candidate cells of any secondary cell, the corresponding third configuration information can also be independently configured. Two of the three candidate cells are configured with one set of third configuration information, and one thereof is configured with two sets of third configuration information.

(2) At least two candidate cells both serve as common candidate cells of at least two serving cells.

Exemplarily, the serving cells currently configured for the UE is a primary cell and one secondary cell, and at least two candidate cells are both the candidate cell of the primary cell and the one secondary cell. That is, in the embodiments of the present application, each candidate cell is the common candidate cell of the primary cell and the one secondary cell, and the candidate list of each serving cell is the same.

As for the embodiments of the present application, various candidate cells serving as candidate cells of a primary cell, the corresponding third configuration information is independently configured, various candidate cells serving as candidate cells of any secondary cell, the corresponding third configuration information is also independently configured. Moreover, the base station will base on the characteristic of each candidate cell to dispatch for it suitable third configuration information. For instance, some candidate cells of at least two candidate cells might be configured with two sets of third configuration information, and some candidate cells might be only configured with one set of third configuration information (corresponding to the primary cell or corresponding to the secondary cell).

In the embodiments of the present application, based on at least one of the foregoing circumstances, the third configuration information of various candidate cells can also be independently configured.

In the embodiments of the present application, on the basis of FIG. 5, the method can further comprise:

Step S105: under the circumstance in which switched cells correspond to a plurality of sets of third configuration information, transmitting based on configuration information corresponding to switched cell types in the plurality of sets of third configuration information.

Taking for example that one candidate cell is simultaneously a candidate cell of a primary cell and a cell of a secondary cell, if this candidate cell is configured with two sets of third configuration information, the first set of third configuration information corresponds to the candidate cell as the primary cell, and the second set of third configuration information corresponds to the candidate cell as the secondary cell. Then, when the primary cell is switched to this candidate cell, transmission is performed based on the first set of third configuration information; when the secondary cell is switched to this candidate cell, transmission is performed based on the second set of third configuration information.

By the method performed by a UE provided by an embodiment of the present application, during the cell switching process of the UE, for the overlapping candidate cell of two serving cells, the configured measurement configuration is small in quantity, and when serving as candidate cells of different serving cells, the corresponding transmission configurations are respectively configured, thus saving measurement report of the UE, satisfying both the transmission and reception requirements as different serving cells, and hence enhancing the performance of the UE.

As for the embodiments of the present application, at least one of the first configuration information, the second configuration information, and the third configuration information is received through high-layer signaling.

Optically, the embodiments of the present application can be applied to indicate switching commands through media access control (MAC) layer signaling or physical layer signaling (such as Downlink Control Information, DCI, but this is not limited hereto), so as to quickly complete the technique of switching among cells, to reduce time delay of switching among cells.

Based on at least one embodiment above, as shown in FIG. 6, there is provided a complete process of cell dynamic switching, and the process mainly includes the following.

Step S201: receiving candidate cell configuration signaling (corresponding to first configuration information), and determining candidate cells.

That is to say, the base station configures a candidate cell for the UE, and transmits candidate cell configuration signaling. The UE receives the candidate cell configuration signaling, and determines various configured candidate cells of serving cells. Reference can be made to the foregoing introduction to step S101 for detail implementation, while no redundancy is made in this context.

Step S202: receiving first signaling, determining measurement configuration (corresponding to second configuration information) of the candidate cells.

That is to say, the base station configures for the candidate cells configurations related to measurement required for switching, and transmits first signaling. The UE receives the first signaling and determines measurement configurations of the various candidate cells. Reference can be made to the foregoing introduction to step S102 and step S103 for detail implementation, while no redundancy is made in this context.

Step S203: receiving second signaling, determining a transmission configuration (corresponding to third configuration information) of the candidate cells.

That is to say, the base station configures relevant information for the candidate cells, and transmits second signaling. The UE receives the second signaling, and determines measurement configurations of the various candidate cells. Reference can be made to the foregoing introduction to step S104 for detail implementation, while no redundancy is made in this context.

Step S204: receiving a switching command, and determining a transmission configuration of the cell switched to according to the cell switched to as indicated in the switching command.

That is to say, the base station configures for the UE the cell to be switched, and transmits a switching command. The UE receives the switching command, determines the cell after switching, and determines transmission configuration of the cell after switching in conjunction with the second signaling. Reference can be made to the foregoing introduction to step S105 for detail implementation, while no redundancy is made in this context.

In conjunction with at least one foregoing embodiment, the above and other characteristics and objectives of the present application will be described below through several examples of cell switching, so as to make the solution clearer.

### Example 1

The serving cell type configured by the UE can be at least one of a primary cell, a PUCCH secondary cell, and a general secondary cell. For instance, serving cells configured by the UE can also be the primary cell and the PUCCH secondary cell, and serving cells configured by the UE can also be the primary cell, PUCCH secondary cell, and general secondary cell. In this Example 1, explanation is made with an example that serving cells currently configured by the UE are a primary cell and a general secondary cell (to facilitate description, shortened as secondary cell in the following description).

The UE receives candidate cell configuration signaling, and the candidate cell configuration signaling configures that candidate cells of the primary cell are candidate cell 1, candidate cell 2, and candidate cell 3, and that candidate cells of the secondary cell are candidate cell 3 and candidate cell 4. Candidate cell 3 serves simultaneously as the candidate cell of two serving cells.

The UE receives first signaling, and the first signaling configures the measurement configurations of candidate cell 1, candidate cell 2, candidate cell 3 and candidate cell 4, of these, for candidate cell 3, it is merely configured one measurement configuration, to save measurement report of UE. The UE transmits the corresponding measurement result according to the measurement configurations of the configured candidate cells.

The UE receives second signaling, the second signaling configures transmission configurations with candidate cell 1, candidate cell 2 and candidate cell 3 serving as candidate cells of the primary cell, and second signaling configures transmission configurations with candidate cell 3 and candidate cell 4 serving as candidate cells of the secondary cell. For the candidate cell 3, transmission configurations of candidate cell 3 serving as a candidate cell of the primary cell and serving as a candidate cell of the secondary cell are respectively independently configured. Moreover, the transmission configuration of each candidate cell can also be independently configured.

The UE receives a switching command, and determines the transmission configuration of the cell switched to according to the cell switched to as indicated in the switching command, for a candidate cell merely serving as the candidate cell of the primary cell (such as the aforementioned candidate cell 1, candidate cell 2), if the primary cell is switched to this candidate cell, this candidate cell employs the transmission configuration serving as the primary cell; for a candidate cell serving merely as the candidate cell of the secondary cell (such as the aforementioned candidate cell 4), if the secondary cell is switched to this candidate cell, this candidate cell employs the transmission configuration serving as the secondary cell. For a candidate cell serving simultaneously as the candidate cell of different serving cells (such as the aforementioned candidate cell 3), if the primary cell is switched to this candidate cell, this candidate cell employs the transmission configuration serving as the primary cell, if the secondary cell is switched to this candidate cell, this candidate cell employs the transmission configuration serving as the secondary cell.

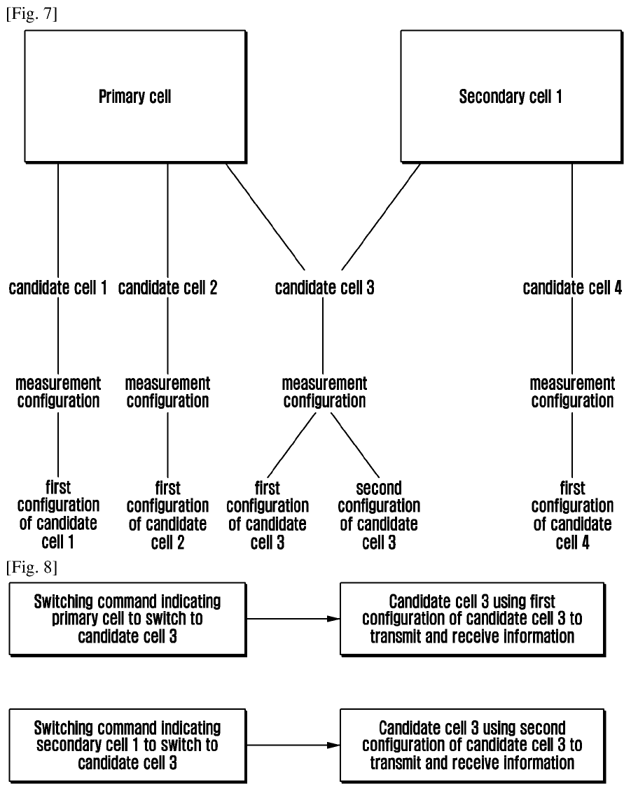

For instance, as shown in FIG. 7, taking for example that the serving cells currently configured by the UE are the primary cell and secondary cell 1, the UE receives candidate cell configuration signaling, and the candidate cell configuration signaling configures the candidate cells of the primary cell as candidate cell 1, candidate cell 2 and candidate cell 3, and configures the candidate cells of secondary cell 1 as candidate cell 3 and candidate cell 4. Wherein, candidate cell 3 serves simultaneously as the candidate cell of the two serving cells.

The UE receives first signaling, and the first signaling configures the measurement configurations of candidate cell 1, candidate cell 2, candidate cell 3 and candidate cell 4, wherein, for candidate cell 3, it is merely configured one measurement configuration, to save measurement report of UE. The UE transmits measurement results of candidate cell 1, candidate cell 2, candidate cell 3, and candidate cell 4 according to the measurement configurations of candidate cell 1, candidate cell 2, candidate cell 3, and candidate cell 4.

The UE receives second signaling, the second signaling configures the transmission configurations of candidate cell 1, candidate cell 2 and candidate cell 3 serving as candidate cells of the primary cell respectively as: first configuration of candidate cell 1, first configuration of candidate cell 2, and first configuration of candidate cell 3, and configures the transmission configurations of candidate cell 3 and candidate cell 4 serving as candidate cells of secondary cell 1 respectively as: second configuration of candidate cell 3 and first configuration of candidate cell 4.

Alternatively, the UE receives second signaling, and second signaling independently configures transmission configurations of candidate cell 1, candidate cell 2, candidate cell 3 and candidate cell 4, and independently configures transmission configuration of candidate cell 3 serving as the candidate cell of the primary cell and transmission configuration of candidate cell 3 serving as the candidate cell of the secondary cell. Specifically:
configuring candidate cell 1 with one set of transmission configuration, that is, transmission configuration serving as candidate cell of the primary cell, corresponding to the first configuration of candidate cell 1;
configuring candidate cell 2 with one set of transmission configuration, that is, transmission configuration serving as candidate cell of the primary cell, corresponding to the first configuration of candidate cell 2;
configuring candidate cell 3 with two sets of transmission configurations, that is, third configuration information serving as candidate cell of the primary cell, corresponding to the first configuration of candidate cell 3, and transmission configuration serving as candidate cell of secondary cell 1, corresponding to the second configuration of candidate cell 3;
configuring candidate cell 4 with one set of transmission configuration, that is, transmission configuration serving as candidate cell of the secondary cell 1, corresponding to the first configuration of candidate cell 4.

When the UE receives the switching command, if the primary cell is switched to candidate cell 3, then candidate cell 3 uses the first configuration of candidate cell 3 to transmit and receive information. When the UE receives the switching command, if secondary cell 1 is switched to candidate cell 3, then candidate cell 3 uses the second configuration of candidate cell 3 to transmit and receive information, as shown in FIG. 8.

The benefit of employing this solution is that, a candidate cell serving not only as the candidate cell of the primary cell and but also as the candidate cell of secondary cell 1 (such as the aforementioned candidate cell 3) is merely configured with one measurement configuration, while transmission configurations serving as the candidate cell of the primary cell and the secondary cell are independently configured, thus satisfying the transmission and reception requirements as the primary cell and the secondary cell at the same time of saving measurement report.

### Example 2

The serving cell type configured by the UE can be at least one of a primary cell, a PUCCH secondary cell and a general secondary cell. For instance, the serving cells configured by the UE can also be the primary cell and the PUCCH secondary cell, and the serving cells configured by the UE can also be the primary cell, the PUCCH secondary cell and the general secondary cell. In this Example 2, explanation is made with an example that the serving cells currently configured by the UE are the primary cell and the general secondary cell (to facilitate description, hereinafter shortened as secondary cell).

The UE receives candidate cell configuration signaling, and the candidate cell configuration signaling configures the common candidate cells of the primary cell and the secondary cell as candidate cell 1, candidate cell 2, candidate cell 3, and candidate cell 4. That it so say, four candidate cells simultaneously serve as candidate cells of two serving cells.

The UE receives first signaling, the first signaling configures measurement configurations of candidate cell 1, candidate cell 2, candidate cell 3 and candidate cell 4, wherein each candidate cell is merely configured with one measurement configuration to save measurement report of UE. The UE transmits corresponding measurement results according to the measurement configurations of the configured candidate cells.

The UE receives second signaling, the second signaling configures transmission configurations of candidate cell 1, candidate cell 2, candidate cell 3 and candidate cell 4 serving as candidate cells of the primary cell, and transmission configurations of candidate cell 1, candidate cell 2, candidate cell 3 and candidate cell 4 serving as candidate cells of the secondary cell. Alternatively, the UE receives second signaling, the second signaling configures transmission configurations of candidate cell 1, candidate cell 2, candidate cell 3 and candidate cell 4, wherein the transmission configuration of each candidate cell serving as the candidate cell of the primary cell and the transmission configuration of each candidate cell serving as the candidate cell of the secondary cell are respectively independently configured, and the transmission configuration of each candidate cell is independently configured.

The UE receive the switching command, and determines the transmission configuration of the cell switched to according to the cell switched to as indicated in the switching command, for anyone candidate cell, if the primary cell is switched to this candidate cell, this candidate cell uses the transmission configuration serving as the primary cell; if the secondary cell is switched to this candidate cell, this candidate cell uses the transmission configuration serving as the secondary cell.

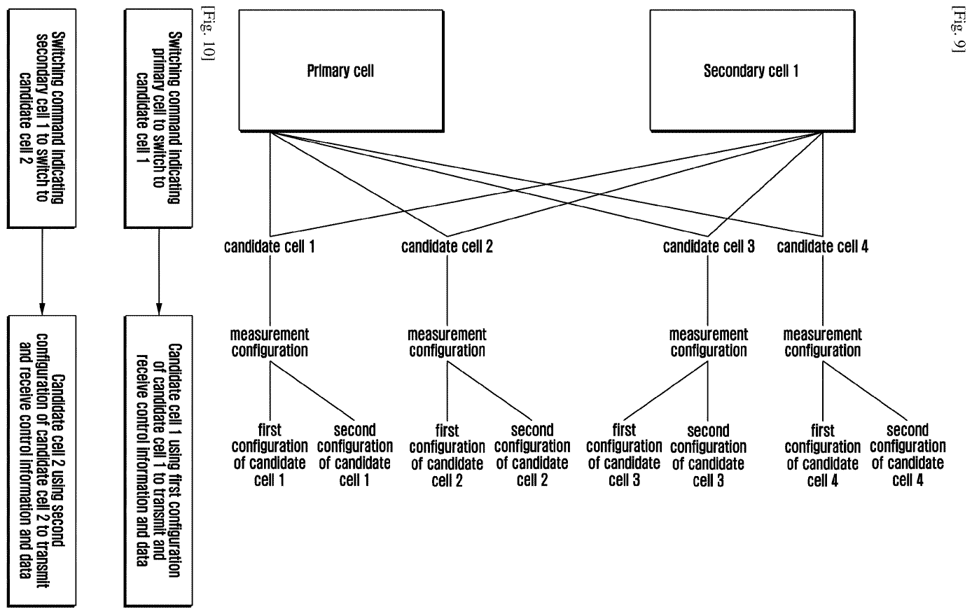

For instance, as shown in FIG. 9, taking an example in which the serving cells currently configured by the UE are the primary cell and the secondary cell 1, the UE receives candidate cell configuration signaling, and the candidate cell configuration signaling configures the common candidate cells of the primary cell and secondary cell 1 as candidate cell 1, candidate cell 2, candidate cell 3 and candidate cell 4. That is to say, the four candidate cells simultaneously serve as candidate cells of the two serving cells.

The UE receives first signaling, the first signaling configures the measurement configurations of candidate cell 1, candidate cell 2, candidate cell 3 and candidate cell 4, wherein each candidate cell is merely configured with one measurement configuration to save measurement report of UE. The UE transmits measurement results of candidate cell 1, candidate cell 2, candidate cell 3, and candidate cell 4 according to the measurement configurations of candidate cell 1, candidate cell 2, candidate cell 3, and candidate cell 4.

The UE receives second signaling, the second signaling configures transmission configurations of candidate cell 1, candidate cell 2, candidate cell 3, and candidate cell 4 serving as candidate cells of the primary cell respectively as: the first configuration of candidate cell 1, the first configuration of candidate cell 2, the first configuration of candidate cell 3 and the first configuration of candidate cell 4; and configures transmission configurations of candidate cell 1, candidate cell 2, candidate cell 3, and candidate cell 4 serving as candidate cells of the secondary cell 1 respectively as: the second configuration of candidate cell 1, the second configuration of candidate cell 2, the second configuration of candidate cell 3 and the second configuration of candidate cell 4.

Alternatively, the UE receives second signaling, the second signaling independently configures transmission configurations of candidate cell 1, candidate cell 2, candidate cell 3, and candidate cell 4, and independently configures transmission configuration of each candidate cell serving as candidate cell of the primary cell and transmission configuration of each candidate cell serving as candidate cell of the secondary cell. Specifically:
configuring candidate cell 1 with two sets of transmission configurations, that is, transmission configuration serving as the candidate cell of the primary cell, corresponding to first configuration of candidate cell 1, and transmission configuration serving as the candidate cell of the secondary cell 1, corresponding to second configuration of candidate cell 1;
configuring candidate cell 2 with two sets of transmission configurations, that is, transmission configuration serving as the candidate cell of the primary cell, corresponding to first configuration of candidate cell 2, and transmission configuration serving as the candidate cell of secondary cell 1, corresponding to second configuration of candidate cell 2;
configuring candidate cell 3 with two sets of transmission configurations, that is, transmission configuration serving as the candidate cell of the primary cell, corresponding to first configuration of candidate cell 3, and transmission configuration serving as the candidate cell of the secondary cell 1, corresponding to second configuration of candidate cell 3; and
configuring candidate cell 4 with two sets of transmission configurations, that is, transmission configuration serving as the candidate cell of the primary cell, corresponding to first configuration of candidate cell 4, and transmission configuration serving as the candidate cell of the secondary cell 1, corresponding to second configuration of candidate cell 4.

When the UE receives the switching command, if the primary cell is switched to candidate cell 1, candidate cell 1 uses the first configuration of candidate cell 1 to transmit and receive information. When the UE receives the switching command, if secondary cell 1 is switched to candidate cell 2, candidate cell 2 uses the second configuration of candidate cell 2 to transmit and receive information, as shown in FIG. 10.

The benefit of employing this solution is that, for a candidate cell, it can be flexibly configured as the candidate cell of the primary cell, candidate cell of the secondary cell, or not only the candidate cell of the primary cell but also the candidate cell of the secondary cell according to characteristic of the candidate cell. In addition, for a cell that not only is a candidate cell of the primary cell but also a candidate cell of secondary cell 1, only one measurement configuration is configured, while transmission configurations of the primary cell and the secondary cell are independently configured, thus satisfying transmission and reception requirements as the primary cell and the secondary cell at the same time of saving measurement report.

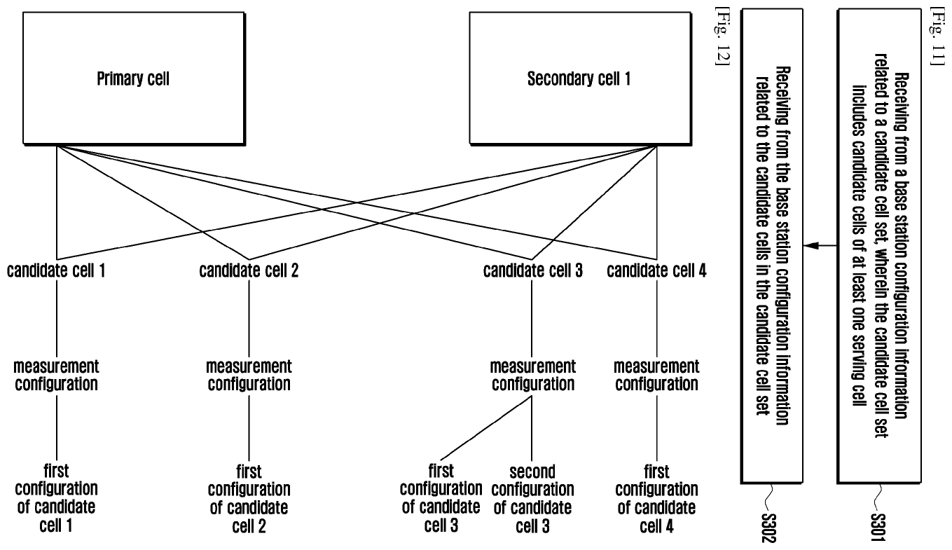

An embodiment of the present application provides another method performed by a UE in a communication system, as shown in FIG. 11, the method comprises:

Step S301: receiving from a base station configuration information related to a candidate cell set, wherein the candidate cell set includes candidate cells of at least one serving cell; and
Step S302: receiving from the base station configuration information related to the candidate cells in the candidate cell set.

Optionally, various candidate cells in the candidate cell set can all serve as common candidate cells of various serving cells. Taking for example that serving cells configured by the UE are a primary cell and one secondary cell, various candidate cells in the candidate cell set can not only serve as candidate cells of the primary cell but also candidate cells of the secondary cell.

In the embodiments of the present application, the base station performs corresponding configuration for the candidate cells in the candidate cell set.

Optionally, configuration information related to candidate cells includes second configuration information related to candidate cell measurement, the method further comprises: performing cell measurement based on the second configuration information.

In the embodiments of the present application, the specific configuration mode of the second configuration information is not defined. For instance, it can be performed according to the mode of the aforementioned step S102 and step S103, and reference can be made to the foregoing introduction for the specific execution mode, while no redundancy is made in this context. It is also possible to perform according to any random mode, for instance, each time a candidate cell serves as the candidate cell of a serving cell, one measurement configuration can be configured therefor, but this is not limited hereto.

Optionally, configuration information related to candidate cells includes third configuration information related to candidate cell transmission; the candidate cell is configured with at least one set of third configuration information.

Wherein, the sets of third configuration information configured for different candidate cells can be identical or different.

Reference can be made to the introduction of Step S104 for the specific execution mode, while no redundancy is made in this context.

In the embodiments of the present application, the method can further comprise: under the circumstance in which switched cells correspond to a plurality of sets of third configuration information, transmitting based on configuration information corresponding to switched cell types in the plurality of sets of third configuration information.

Reference can be made to the introduction of Step S105 for the specific execution mode, while no redundancy is made in this context.

Based on at least one foregoing embodiment, in conjunction with FIG. 6, a complete process of cell dynamic switching in the embodiments of the present application mainly includes the following.

Step S201: receiving candidate cell configuration signaling (corresponding to the first configuration information), including configuration information related to the candidate cell set, and determining candidate cells.

That is, the base station configures a candidate cell set for the UE, and transmits the candidate cell configuration signaling. The UE receives the candidate cell configuration signaling, and determines the configured candidate cell set of the serving cells. Reference can be made to the introduction of the foregoing Step S301 for specific implementation, while no redundancy is made in this context.

Step S202: receiving first signaling, and determining measurement configuration (corresponding to the second configuration information) of the candidate cell.

Step S203: receiving second signaling, and determining a transmission configuration (corresponding to the third configuration information) of the candidate cells.

Step S204: receiving a switching command, and determining a transmission configuration of the cell switched to according to the cell switched to as indicated in the switching command.

Reference can be made to the foregoing description for the execution modes of Steps S202 to Step S204, while no redundancy is made in this context.

By the method performed by a UE provided by an embodiment of the present application, for a candidate cell, it can be flexibly configured as the candidate cell of the primary cell, candidate cell of the secondary cell, or not only the candidate cell of the primary cell but also the candidate cell of the secondary cell according to characteristic of the candidate cell. In addition, for a candidate cell that not only is a candidate cell of the primary cell but also a candidate cell of secondary cell, the third configuration information of the primary cell and the secondary cell is independently configured, thus satisfying the transmission and reception requirements as the primary cell and the secondary cell.

In conjunction with at least one foregoing embodiment, the above and other characteristics and objectives of the embodiments of the present application are described with an example of cell switching, so as to make the solution clearer.

### Example 3

The serving cell type configured by the UE can be at least one of a primary cell, a PUCCH secondary cell and a general secondary cell. For instance, the serving cells configured by the UE can also be a primary cell and a PUCCH secondary cell, and the serving cells configured by the UE can also be the primary cell, the PUCCH secondary cell, and a general secondary cell. In this Example 3, explanation is made with an example in which the serving cells currently configured by the UE are a primary cell and a general secondary cell (to facilitate description, hereinafter shortened as a secondary cell).

The UE receives candidate cell set configuration signaling, the candidate cell set configuration signaling configures candidate cell 1, candidate cell 2, candidate cell 3, and candidate cell 4, all of which can serve as common candidate cells of the primary cell and the secondary cell.

The UE receives first signaling, the first signaling configures measurement configurations of candidate cell 1, candidate cell 2, candidate cell 3 and candidate cell 4, wherein each candidate cell is merely configured with one measurement configuration to save measurement report of UE. The UE transmits corresponding measurement results according to the measurement configurations of the configured candidate cells.

The UE receives second signaling, the base station takes consideration of candidate cell 1 and candidate cell 2, configures the second signaling with transmission configurations with candidate cell 1 and candidate cell 2 serving as candidate cells of the primary cell, and the base station takes consideration of the characteristic of candidate cell 3, configures the second signaling with transmission configuration with candidate cell 3 serving as candidate cell of the primary cell and transmission configuration with candidate cell 3 serving as candidate cell of the secondary cell, and the base station takes consideration of characteristic of candidate cell 4, and configures the second signaling with transmission configuration with candidate cell 4 serving as candidate cell of the secondary cell. Moreover, the transmission configuration of each candidate cell can also be independently configured.

The UE receives a switching command, and determines the transmission configuration of the cell switched to according to the cell switched to as indicated in the switching command, for candidate cells with which only one set of transmission configuration is configured (such as the aforementioned candidate cell 1, candidate cell 2, and candidate cell 4), if the primary cell or the secondary cell switches to these candidate cells, corresponding transmission configuration can be used; as for a candidate cell with which two sets of transmission configurations is configured (such as the aforementioned candidate cell 3), the corresponding configuration is determined according to the switched cell type, if the primary cell is switched to this candidate cell, this candidate cell uses the transmission configuration serving as the primary cell, if the secondary cell is switched to this candidate cell, this candidate cell uses the transmission configuration serving as the secondary cell.

For instance, as shown in FIG. 12, taking for example serving cells currently configured by the UE are a primary cell and secondary cell 1, the UE receives the candidate cell set configuration signaling, and the candidate cell set configuration signaling configures common candidate cells of the primary cell and secondary cell 1 as candidate cell 1, candidate cell 2, candidate cell 3 and candidate cell 4.

The UE receives first signaling, the first signaling configures measurement configurations of candidate cell 1, candidate cell 2, candidate cell 3 and candidate cell 4, wherein each candidate cell is merely configured with one measurement configuration to save measurement report of UE. The UE transmits measurement results of candidate cell 1, candidate cell 2, candidate cell 3 and candidate cell 4 according to measurement configurations of candidate cell 1, candidate cell 2, candidate cell 3 and candidate cell 4.

The UE receives second signaling, the second signaling configures transmission configurations of candidate cell 1, candidate cell 2, candidate cell 3 serving as candidate cells of the primary cell respectively as: the first configuration of candidate cell 1, the first configuration of candidate cell 2, and the first configuration of candidate cell 3, and configures the transmission configurations of candidate cell 3 and candidate cell 4 serving as candidate cells of secondary cell 1 respectively as: the second configuration of candidate cell 3 and the first configuration of candidate cell 4. Alternatively, the UE receives second signaling, the second signaling independently configures transmission configurations of candidate cell 1, candidate cell 2, candidate cell 3 and candidate cell 4, and independent configures the transmission configuration of candidate cell 3 serving as candidate cell of the primary cell and the transmission configuration serving as candidate cell of the secondary cell. In other words, the base station configures one set of transmission configuration for each of candidate cell 1, candidate cell 2 and candidate cell 4, and configures two sets of transmission configurations for candidate cell 3. Specifically:
configuring candidate cell 1 with one set of transmission configuration, that is, the transmission configuration serving as the candidate cell of the primary cell, corresponding to the first configuration of candidate cell 1;
configuring candidate cell 2 with one set of transmission configuration, that is, the transmission configuration serving as the candidate cell of the primary cell, corresponding to the first configuration of candidate cell 2;
configuring candidate cell 3 with two sets of transmission configurations, that is, the third configuration information serving as the candidate cell of the primary cell, corresponding to the first configuration of candidate cell 3, and the transmission configuration serving as the candidate cell of secondary cell 1, corresponding to the second configuration of candidate cell 3;
configuring candidate cell 4 with one set of transmission configuration, that is, the transmission configuration serving as the candidate cell of secondary cell 1, corresponding to the first configuration of candidate cell 4.

When the UE receive a switching command, if the primary cell is switched to candidate cell 1, then candidate cell 1 uses the first configuration of candidate cell 1 to transmit and receive information. When the UE receives a switching command, if secondary cell 1 is switched to candidate cell 3, then candidate cell 3 uses the second configuration of candidate cell 3 to transmit and receive information, as shown in FIG. 13.

An embodiment of the present application further provides a method performed by a base station in a communication system, the method comprises:
Step S401: transmitting to a UE first configuration information related to candidate cells of a serving cell of the UE; and
Step S402: transmitting to the UE second configuration information related to candidate cell measurement, wherein the second configuration information is used for the UE to perform cell measurement.

Wherein, under the circumstance in which there are overlapping candidate cells of serving cells, the overlapping candidate cells of at least two serving cells are configured with a same measurement configuration.

In an optional implementation, the overlapping candidate cells are configured with a same measurement configuration, includes at least one of the following circumstances:
the overlapping candidate cells are configured with a same second configuration information; and
the overlapping candidate cells are configured with a same measurement identifier.

In an optional implementation, candidate cells corresponding to the first type service among the overlapping candidate cells are configured with a same first measurement configuration, and candidate cells corresponding to the second type serving cell among the overlapping candidate cells are configured with a same second measurement configuration.

In an optional implementation, the first type serving cell is a primary cell, and the second type serving cell is a secondary cell; and/or

the first type serving cell is a PUCCH secondary cell, and the second type serving cell is other secondary cell.

In an optional implementation, the method further comprises:

Step S403: transmitting to the UE third configuration information related to candidate cell transmission.

In an optional implementation, each candidate cell is configured with at least one set of third configuration information.

In an optional implementation, the sets of third configuration information configured for different candidate cells are identical or different.

In an optional implementation, the method further comprises:

Step S404: under the circumstance in which cells after UE switching correspond to a plurality of sets of third configuration information, transmitting based on configuration information corresponding to cell types after UE switching in the plurality of sets of third configuration information.

In an optional implementation, at least one of the first configuration information, the second configuration information and the third configuration information is transmitted through high-layer signaling.

An embodiment of the present application further provides a method performed by a base station in a communication system, the method comprises:
Step S501: transmitting to a UE configuration information related to a candidate cell set, wherein the candidate cell set includes candidate cells of at least one serving cell; and

transmitting to the UE configuration information related to candidate cells in the candidate cell set.

In an optional implementation, the configuration information related to candidate cells includes third configuration information related to candidate cell transmission.

The candidate cell is configured with at least one set of third configuration information.

In an optional implementation, the sets of third configuration information configured for different candidate cells are identical or different.

In an optional implementation, the method further comprises: under the circumstance in which cells after UE switching correspond to a plurality of sets of third configuration information, transmitting based on the configuration information corresponding to cell types after UE switching in the plurality of sets of third configuration information.

The methods performed by the base station in the various embodiments of the present application are corresponding to the methods of the UE-side various embodiments, reference can be made to the description in the corresponding methods illustrated in the foregoing UE-side various embodiments for the detailed function description and advantageous effects, while no redundancy is made in this context.

An embodiment of the present application further provides an electronic equipment, the electronic equipment comprises a memory, a processor and a computer program stored on the memory, when the processor executes the computer program, the steps of the methods provided by the various method embodiments of the present application can be realized. Optionally, the electronic equipment can be the UE, or the electronic equipment can be the base station.

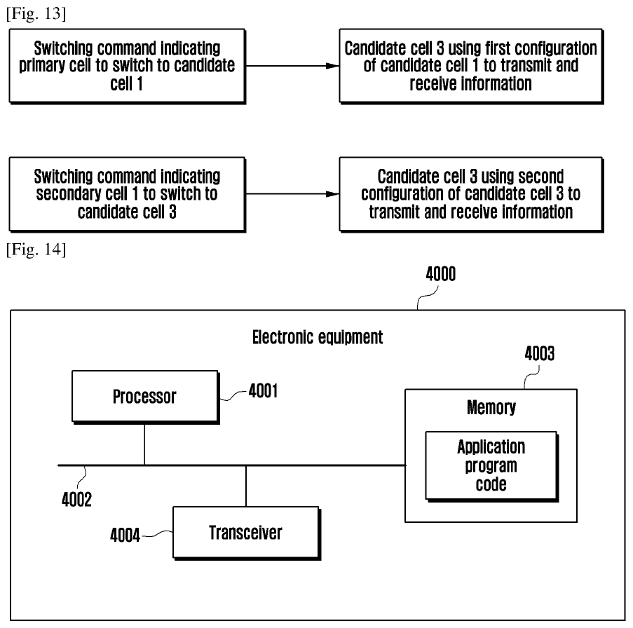

In an optional embodiment, there is provided an electronic equipment, as shown in FIG. 14, an electronic equipment 4000 illustrated in FIG. 14 comprises a processor 4001 and a memory 4003. Wherein, the processor 4001 is connected to memory 4003, such as connected through a bus 4002. Optionally, the electronic equipment 4000 can further comprise a transceiver 4004, the transceiver 4004 can be used for data in-teraction between the electronic equipment and other electronic equipments, such as transmission of data and/or reception of data, and so on. As should be noted, in an actual application the transceiver 4004 is not limited to one, and the structure of the electronic equipment 4000 does not constitute any restriction to the embodiments of the present application.

The processor 4001 may be a central processing unit (CPU), a general-purpose processor, a digital signal processor (DSP), an application specific integrated circuit (ASIC), or a field programmable gate array (FPGA), or other programmable logic devices, transistor logic devices, hardware components, or any combination thereof. It may implement or execute various exemplary logical blocks, modules and circuits described in connection with the present disclosure. The processor 4001 may also be a combination for realizing computing functions, for example, a combination of one or more microprocessors, a combination of a DSP and a microprocessor, etc.

The bus 4002 may include a path to transfer information between the components described above. The bus 4002 may be a peripheral component interconnect (PCI) bus, or an extended industry standard architecture (EISA) bus, etc. The bus 4002 may be an address bus, a data bus, a control bus, etc. For ease of presentation, the bus is rep-resented by only one thick line in FIG. 14. However, it does not mean that there is only one bus or one type of buses.

The memory 4003 may be read only memories (ROMs) or other types of static storage devices that can store static information and instructions, random access memories (RAMs) or other types of dynamic storage devices that can store information and instructions, may be electrically erasable programmable read only memories (EEPROMs), compact disc read only memories (CD-ROMs) or other optical disk storages, optical disc storages (including compact discs, laser discs, discs, digital versatile discs, blue-ray discs, etc.), magnetic storage media or other magnetic storage devices, or any other media that can carry or store desired program codes in the form of instructions or data structures and that can be accessed by computers.

The memory 4003 is used to store application program codes for executing the embodiment of the present application, and is controlled by the processor 4001. The processor 4001 is used to execute the application program codes stored in the memory 4003 to implement the step shown in the foregoing method embodiment.

Embodiments of the present application provide a computer-readable storage medium having a computer program stored on the computer-readable storage medium, the computer program, when executed by a processor, implements the steps and corresponding contents of the foregoing method embodiments.

Embodiments of the present application also provide a computer program product including a computer program, the computer program when executed by a processor realizing the steps and corresponding contents of the preceding method embodiments.

The terms “first”, “second”, “third”, “fourth”, “1”, “2”, etc. (if present) in the speci-fication and claims of this application and the accompanying drawings above are used to distinguish similar objects and need not be used to describe a particular order or sequence. It should be understood that the data so used is interchangeable where ap-propriate so that embodiments of the present disclosure described herein can be implemented in an order other than that illustrated or described in the text.

It should be understood that while the flow diagrams of embodiments of the present disclosure indicate the individual operational steps by arrows, the order in which these steps are performed is not limited to the order indicated by the arrows. Unless ex-plicitly stated herein, in some implementation scenarios of embodiments of the present disclosure, the implementation steps in the respective flowcharts may be performed in other orders as desired. In addition, some, or all of the steps in each flowchart may include multiple sub-steps or multiple phases based on the actual implementation scenario. Some or all of these sub-steps or stages can be executed at the same moment, and each of these sub-steps or stages can also be executed at different moments separately. The order of execution of these sub-steps or stages can be flexibly configured according to requirements in different scenarios of execution time, and the embodiments of the present disclosure are not limited thereto.

The foregoing description merely shows the optional implementations of some implementation scenarios of the present application. It should be pointed out that, for a person of ordinary skill in the art, without departing from the technical concept of the solutions of the present application, other similar implementation means based on the technical concept of the present application shall also fall into the protection scope of the embodiments of the present application.

1. A method of a user equipment (UE) in a wireless communication system, the method comprising:
receiving, from a base station, first configuration information related to candidate cells of serving cells;
receiving, from the base station, second configuration information related to candidate cell measurement; and
performing cell measurement based on the second configuration information;
wherein under the circumstance in which there are overlapping candidate cells of the serving cells, overlapping candidate cells of at least two serving cells are configured with a same measurement configuration.

2. The method of claim 1, wherein the overlapping candidate cells are configured with a same measurement configuration, includes at least one of the following circumstances:
the overlapping candidate cells are configured with a same second configuration information, and
the overlapping candidate cells are configured with a same measurement identifier.

3. The method of claim 1,
wherein candidate cells that correspond to a first type serving cell among the overlapping candidate cells are configured with a same first measurement configuration, and candidate cells that correspond to a second type serving cell among the overlapping candidate cells are configured with a same second measurement configuration,
wherein the first type serving cell is a primary cell, the second type serving cell is a secondary cell, and
wherein the first type serving cell is a PUCCH secondary cell, and the second type serving cell is another secondary cell.

4. The method of claim 1, further comprising:
receiving, from the base station, third configuration information related to candidate cell transmission;
wherein each candidate cell is configured with at least one set of third configuration information, and
wherein different candidate cells are configured with the same set or different sets of third configuration information.

5. The method of claim 4, further comprising:
under the circumstance in which switched cells correspond to a plurality of sets of third configuration information, transmitting based on configuration information corresponding to switched cell types in the plurality of sets of third configuration information;
wherein at least one of the first configuration information, the second configuration information, and the third configuration information is received through high-layer signaling.

6. A method of a base station in a wireless communication system, the method comprising:
transmitting, to a user equipment (UE), first configuration information related to candidate cells of a serving cell of the UE; and
transmitting, to the UE, second configuration information related to candidate cell measurement, wherein the second configuration information is used for the UE to perform cell measurement;
wherein, under the circumstance in which there are overlapping candidate cells of serving cells, the overlapping candidate cells of at least two serving cells are configured with a same measurement configuration.

7. The method of claim 6, wherein the overlapping candidate cells are configured with a same measurement configuration, includes at least one of the following circumstances:
the overlapping candidate cells are configured with a same second configuration information, and
the overlapping candidate cells are configured with a same measurement identifier.

8. A user equipment (UE) in a wireless communication system, comprising:
a transceiver; and
a processor configured to:
receive, from a base station, first configuration information related to candidate cells of serving cells,
receive, from the base station, second configuration information related to candidate cell measurement, and
perform cell measurement based on the second configuration information,
wherein under the circumstance in which there are overlapping candidate cells of the serving cells, overlapping candidate cells of at least two serving cells are configured with a same measurement configuration.

9. The UE of claim 8, wherein the overlapping candidate cells are configured with a same measurement configuration, includes at least one of the following circumstances:
the overlapping candidate cells are configured with a same second configuration information, and
the overlapping candidate cells are configured with a same measurement identifier.

10. The UE of claim 8,
wherein candidate cells that correspond to a first type serving cell among the overlapping candidate cells are configured with a same first measurement configuration, and candidate cells that correspond to a second type serving cell among the overlapping candidate cells are configured with a same second measurement configuration,
wherein the first type serving cell is a primary cell, the second type serving cell is a secondary cell, and
wherein the first type serving cell is a PUCCH secondary cell, and the second type serving cell is another secondary cell.

11. The UE of claim 8, wherein the processor is further configured to:
receive from the base station third configuration information related to candidate cell transmission,
wherein each candidate cell is configured with at least one set of third configuration information, and
wherein different candidate cells are configured with the same set or different sets of third configuration information.

12. The UE of claim 11, wherein the processor is further configured to:
under the circumstance in which switched cells correspond to a plurality of sets of third configuration information, transmit based on configuration information corresponding to switched cell types in the plurality of sets of third configuration information,
wherein at least one of the first configuration information, the second configuration information, and the third configuration information is received through high-layer signaling.

13. A base station in a wireless communication system, comprising:
a transceiver; and
a processor configured to:
transmit, to a user equipment (UE), first configuration information related to candidate cells of a serving cell of the UE, and transmit, to the UE, second configuration information related to candidate cell measurement, wherein the second configuration information is used for the UE to perform cell measurement,
wherein, under the circumstance in which there are overlapping candidate cells of serving cells, the overlapping candidate cells of at least two serving cells are configured with a same measurement configuration.

14. The base station of claim 13, wherein the overlapping candidate cells are configured with a same measurement configuration, includes at least one of the following circumstances:
the overlapping candidate cells are configured with a same second configuration information, and
the overlapping candidate cells are configured with a same measurement identifier.
